(19) United States
(12) Patent Application Publication
(10) Pub. No.: US 2008/0158097 A1
(43) Pub. Date: Jul. 3, 2008

(54) Display device with six primary colors

(75) Inventor: Wei Guo, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD; INNOLUX DISPLAY CORP.

(21) Appl. No.: 12/005,931

(22) Filed: Dec. 29, 2007

(30) Foreign Application Priority Data
Dec. 29, 2006 (TW) 95149705

(51) Int. Cl. G09G 3/20

(52) U.S. Cl. 345/55

(57) ABSTRACT

An exemplary display device (4) includes a plurality of pixels (41). Each pixel includes a red sub-pixel, a green sub-pixel, a blue sub-pixel, a cyan sub-pixel, a magenta sub-pixel, and a yellow sub-pixel which are capable of displaying red, green, blue, cyan, magenta, and yellow, respectively. each of the cyan, magenta, and yellow sub-pixels are arranged generally between two corresponding of the red, green, and blue sub-pixels.

### FIELD OF THE INVENTION

The present invention relates to display devices, and particularly to a display device with six primary colors.

### BACKGROUND

Vision is a sense mediated by the eye to perceive the qualities of an object, such as color, luminosity, shape, and size. Color is defined as an attribute of visual perception consisting of any combination of chromatic and achromatic content. This attribute can be described by chromatic color names such as yellow, orange, brown, red, pink, green, blue, purple, etc., or by achromatic color names such as white, grey, black, etc; and can be qualified by strengths such as bright, dim, light, dark, etc., or by combinations of such names.

A perceived color depends on the spectral distribution of the color stimulus, on the size, shape, structure and surroundings of the stimulus area, on the state of adaptation of the observer's visual system, and on the observer's experience of the prevailing situation and observations of similar situations.

In the retina of the human eye, only three different types of cells are involved in receiving light. These cells are called L, M and S cones, which are sensitive to light with long (L), medium (M) and short (S) wavelengths, respectively. The three classical long, medium and short wavelength kinds of visible light are red (R), green (G), and blue (B) light. Other different colors can be produced by mixing two or all three of these primary light colors with varying intensities. For example, if red light and green light are mixed, it may be perceived as yellow. If a red light source is initially set to full intensity and an accompanying green light source is initially set to zero intensity, and then the intensity of the green light is increased while the intensity of the red light is decreased, the mixed color changes from red, to orange, to yellow, and finally to green.

According to the above-described principles of light, numerous kinds of color display devices with the three primary colors of red, green, and blue have been developed to display color images.

In contemporary color display devices utilizing the primary colors of red, green and blue, the display device usually includes a multiplicity of pixels arranged in a matrix. Each pixel includes three sub-pixels displaying red, green, and blue, respectively.

FIG. 6 is a schematic plan view of a stripe arrangement of sub-pixels in a conventional color pixel array 1 of a conventional color display device. The stripe arrangement of sub-pixels R, G, B provides a simple array design and requires only a simple driving circuit, but produces relatively poor color homogeneity.

FIG. 7 is a schematic plan view of a mosaic arrangement of sub-pixels in a conventional color pixel array 2 of another conventional color display device. The mosaic arrangement of sub-pixels R, G, B provides a simple array design and better color homogeneity. However, fabrication of the color pixel array 2 is more difficult, and a more complex driving circuit is required.

FIG. 8 is a schematic plan view of a delta arrangement of sub-pixels in a conventional color pixel array 3 of still another conventional color display device. The delta arrangement of sub-pixels R, G, B provides the best color homogeneity and requires only a simple driving circuit. However, the array design is more complex, and fabrication of the color pixel array 3 is more difficult.

FIG. 9 is a CIE 1931 model standardized by the CIE (Commission Internationale del'Eclairage—International Commission on Illumination) to illustrate color sensation. The model is shown in simplified form, to illustrate a color gamut of conventional color display devices. The curved line illustrates chromaticity coordinates of the spectral colors, and the corresponding wavelengths are indicated in nanometers (nm). Chromaticity coordinates for all visible colors are on the horseshoe shaped area inside the curved line. The points R, G, B represent chromaticity coordinates of pure red, green, and blue, respectively. Colors that can be obtained by mixing red, green, and blue are limited to the area within the color triangle ΔRGB, which is defined by the three primary colors of red, green, and blue.

In conventional color display devices, each pixel includes three sub-pixels that can only display the three primary colors of red, green, and blue. In these RGB color displays, the displayable color gamut is limited to the area within the color triangle ΔRGB. Colors outside the color triangle ΔRGB, cannot be rendered completely, and are consequently shifted toward colors that can be displayed. For example, gold and turquoise cannot be rendered completely, and are shifted toward unsaturated yellow and more bluish green. This limits the color display quality of the display device. In other words, the display device has a narrow color gamut.

Accordingly, what is needed is a display device that can overcome the above-described deficiencies.

### SUMMARY

In one aspect, a display device includes a plurality of pixels. Each pixel includes a red sub-pixel, a green sub-pixel, a blue sub-pixel, a cyan sub-pixel, a magenta sub-pixel, and a yellow sub-pixel which are capable of displaying red, green, blue, cyan, magenta, and yellow, respectively. each of the cyan, magenta, and yellow sub-pixels are arranged generally between two corresponding of the red, green, and blue sub-pixels.

In another aspect, a display device includes a multiplicity of pixels. Each pixel includes a first display element, a second display element, and a third display element, which are able to display first, second, and third primary colors, respectively, and a fourth display element, a fifth display element, and a sixth display element, which are able to display fourth, fifth, and sixth primary colors, respectively. the fourth, fifth, and sixth primary colors are complementary colors of the first, second, and third primary colors. the first, second, and third display elements are separated from each other by the fourth, fifth, and sixth display elements.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an abbreviated, top plan view of a display device according to a first embodiment of the present invention, the display device including a display area having a multiplicity of pixels.

FIG. 2 is an enlarged view of part of the display area of FIG. 1, showing details of pixels.

FIG. 3 is a CIE 1931 model standardized by the CIE to illustrate color sensation.

FIG. 4 is a plan view of part of a pixel array according to a second embodiment of the present invention.

FIG. 5 is a plan view of part of a pixel array according to a third embodiment of the present invention.

FIG. 6 is a plan view of a stripe arrangement of sub-pixels in a conventional color pixel array of a conventional color display device.

FIG. 7 is a plan view of a mosaic arrangement of sub-pixels in a conventional color pixel array of another conventional color display device.

FIG. 8 is a plan view of a delta arrangement of sub-pixels in a conventional color pixel array of still another conventional color display device.

FIG. 9 is the CIE 1931 model shown in simplified form, to illustrate a color gamut of conventional color display devices.

### DETAILED DESCRIPTION OF PREFERRED EMBODIMENTS

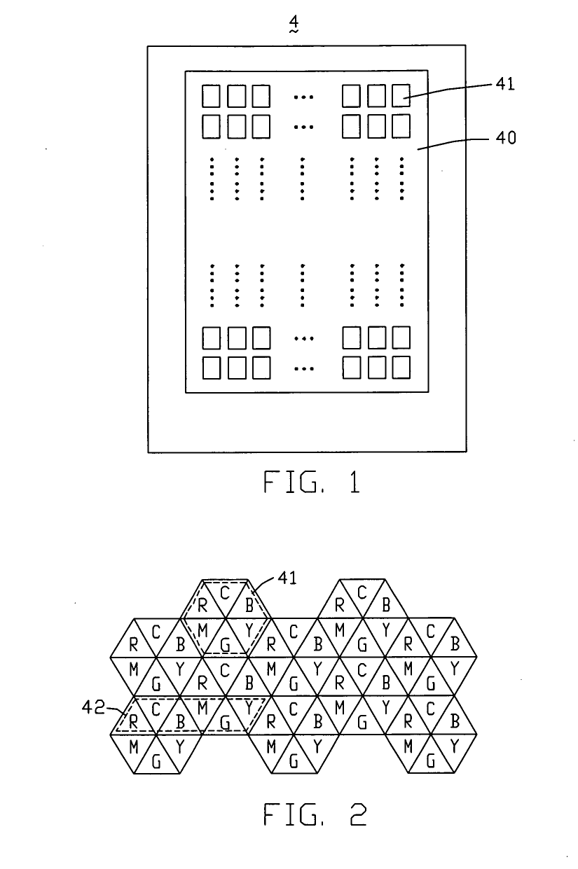

FIG. 1 is a schematic, abbreviated, top plan view of a display device according to a first embodiment of the present invention. The display device 4 includes a display area 40.

FIG. 2 is an enlarged view of part of the display area 40. In one aspect, the display area 40 defines a multiplicity of pixels 41 arranged in a matrix. Each pixel 41 has a regular hexagonal structure. The pixel 41 is divided into six congruent equilateral triangles by three diagonal lines. The six congruent equilateral triangles define six sub-pixels R, G, B, C, M, Y The six sub-pixels R, C, B, C, M, Y respectively display colors of red (R), green (G), blue (B), cyan (C), magenta (M), and yellow (Y). Cyan—is a complementary color of red. Magenta is a complementary color of green. Yellow is a complementary color of blue.

The three sub-pixels R, G, B are located in three of the congruent equilateral triangles of the pixel 41 which are separated from one another. The three sub-pixels C, M, Y are located in the other three congruent equilateral triangles which are also separated from one another. The sub-pixel C is arranged adjacent to the sub-pixel R, the sub-pixel G is arranged adjacent to the sub-pixel M, and the sub-pixel B is arranged adjacent to the sub-pixel Y. Thus, the three sub-pixels R, G, B are separated from each other by the three sub-pixels C, M, Y. Each pixel 41 has the same configuration, and is adjacent to six surrounding pixels 41. Thus the multiplicity of pixels 41 cover the display area 40 completely.

In another aspect, the display area 40 defines a multiplicity of pixels 42 arranged in a matrix. Each pixel 42 includes six sub-pixels R, C, B, C, M, Y in congruent equilateral triangles. The six sub-pixels R, G, B, C, M, Y are arranged in a parallelogram. The equilateral triangles of the three sub-pixels R, G, B all have a same first orientation, standing on their bases as shown in FIG. 2. Thus the three sub-pixels R, G, B are separated from one another. The sub-pixels C, M, Y all have a same second orientation, standing on their points as shown in FIG. 2. Thus the three sub-pixels C, M, Y are separated from one another, by the three sub-pixels R, Q B. The sub-pixels R, C, B, M, G, Y are joined together closely in a row, in that order from left to right as shown in FIG. 2.

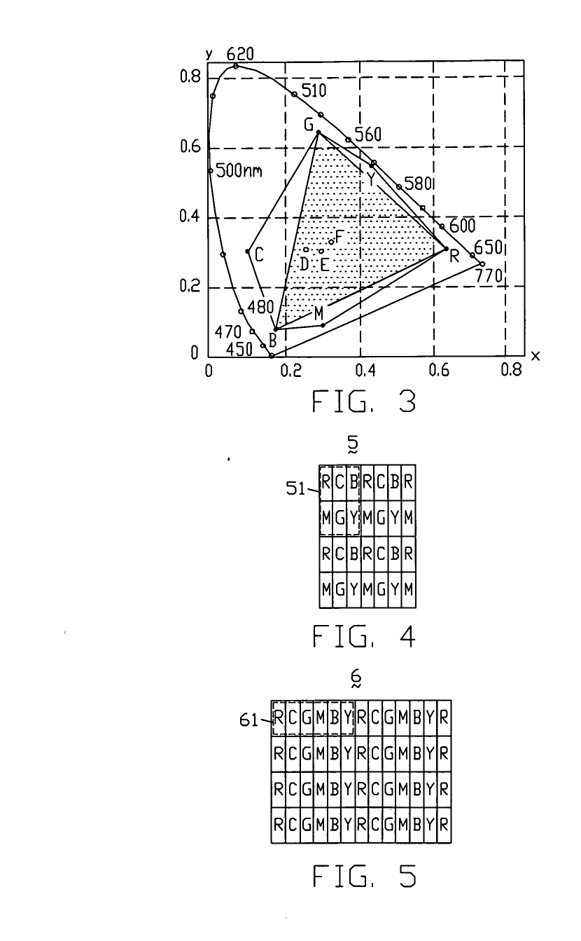

In the CIE 1931 model as shown in FIG. 3, the point E represents a chromaticity coordinate of white produced by the three primary colors R, G, B. A chromaticity coordinate of cyan is set to be at a straight line passing through the point R and the point E. A chromaticity coordinate of magenta is set to be at a straight line passing through the point G and the point E. A chromaticity coordinate of yellow is set to be at a straight line passing through the point E and the point B. As described above, mixing the light of two colors can create a new color. A chromaticity coordinate of the new color is at an imaginary straight line between the two colors. Thus by mixing light of the six primary colors R, G, B, C, M, Y with various intensities, all colors with chromaticity coordinates in the polygon defined by the points RMBCGY can be produced.

Accordingly, a color gamut of the display device 4 with the six primary colors R, G, B, C, M, Y is in the polygon RMBCGY. A color gamut of the RGBCMY six primary color display device 4 is larger than that of an RGB three primary color display device. Moreover, the three primary color sub-pixels R, G, B and the corresponding complementary color sub-pixels C, M, Y are arranged alternately. Therefore the complementary colors C, M, Y effectively complement the primary colors R, G, B of each pixel 41 and of each pixel 42. Thus, much better color homogeneity and uniformity can be obtained. In addition, each regular hexagonal pixel 41 has fully six boundaries with its adjoining pixels 41. This not only contributes to the color homogeneity and uniformity of the display device 4, but also provides a natural transition between different colors. In particular, the colors of cyan and yellow look more natural and fresher.

In addition, the green and yellow colors have higher brightness than the other colors. When the display device 4 needs to display a bright image, the sub-pixels G, Y can illuminate or be illuminated brighter than the other sub-pixels R, B, C, M. This increases a brightness and saturation of colors displayed by the display device 4.

Furthermore, according to color theory, a single color can be produced by mixing different combinations of various of the primary colors. Taking white as an example, this color can be produced by mixing the colors of red, green, and blue, or by mixing the colors of cyan, magenta, and yellow, and even by mixing the colors of red, green, blue, cyan, magenta, and yellow. In FIG. 3, the point E represents the chromaticity coordinate of white obtained by mixing R, G, B. A point F represents a chromaticity coordinate of white obtained by mixing C, M Y A point D represents a chromaticity coordinate of white obtained by mixing R, G, B, C, M, Y. The three coordinates of white obtained by mixing the different combinations of primary colors are close to each other, but still different. Thus when a color needs to be displayed, more than one mixing method is provided. This gives image designers more choices to select an appropriate mixing method to produce desired colors in different situations. Accordingly, a display quality of the display device 4 is improved.

FIG. 4 is a schematic, plan view of part of a pixel array 5 according to a second embodiment of the present invention. The pixel array 5 includes a multiplicity of pixels 51 arranged in a matrix. Each pixel 51 has a rectangular structure, and includes six sub-pixels R, G, B, C, M, Y. The six sub-pixels R, G, B, C, M, Y. are arranged in a matrix with 2 rows and 3 columns. The sub-pixels R, C, B are arranged in that order from left to right in the first row, as shown in FIG. 4. The sub-pixels M, G, Y are arranged in that order from left to right in the second row, as shown in FIG. 4. Thus, the three primary color sub-pixels R, G, B are collocated like a delta, the delta standing on its point as shown in FIG. 4. The three complementary color sub-pixels C, M, Y are collocated like another delta, the delta standing on its base as shown in FIG. 4. The two deltas overlap each other to form the rectangular structure.

In the pixel array 5, each of the primary color sub-pixels R, G, B is adjacent to two corresponding of the three complementary color sub-pixels C, M, Y. This arrangement enhances a color homogeneity of the pixel array 5. The arrangement also provides a simple array design, and requires only simple fabrication procedures and a simple driving circuit.

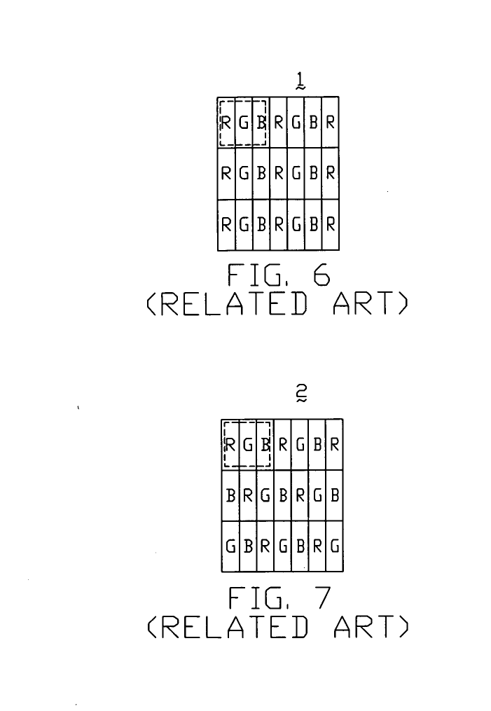

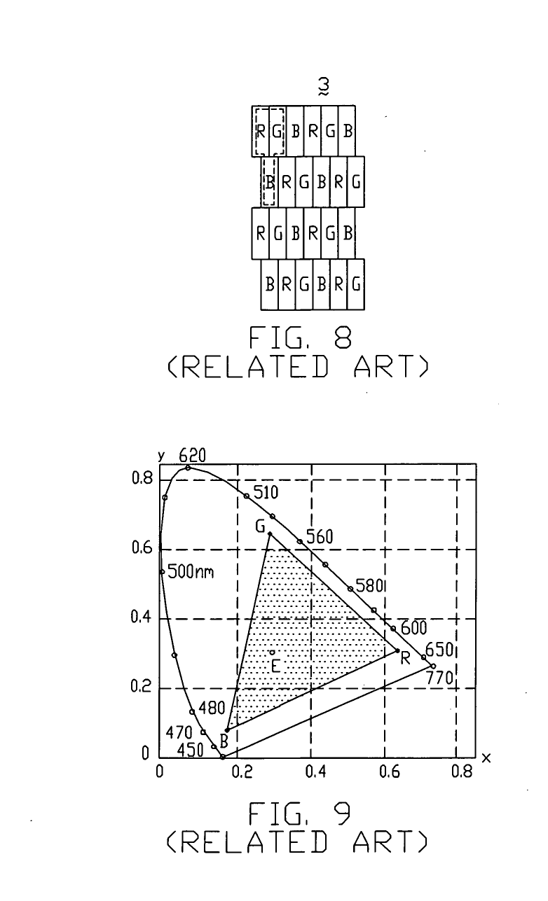

FIG. 5 shows a schematic, plan view of part of a pixel array 6 according to a third embodiment of the present invention. The pixel array 6 has a structure similar to that of the pixel array 5. However, each pixel 61 has an elongate rectangular structure, and includes six sub-pixels R, C, G, M, B, Y. The six sub-pixels R, C, G, M, B, Y are arranged in a stripe structure in that order from left to right, as shown in FIG. 5. Thus, the three primary color sub-pixels R, G, B are separated from each other by the three complementary color sub-pixels C, M, Y. In particular, each complementary color sub-pixel C, M, Y follows the corresponding respective primary color sub-pixel R, G, B.

In alternative embodiments, the sub-pixels R, Q B can have their positions interchanged in any of various other possible combinations. The sub-pixels C, M, Y can correspondingly have their positions interchanged in any of various other possible combinations. These arrangements also provide simple array designs, and require only simple fabrication procedures and simple driving circuitries.

In general, the present invention relates to the field of display devices. The display devices can for example be liquid crystal displays (LCDs), cathode ray tube (CRT) displays, flat intelligent tube (FIT) displays, light emitting diode (LED) displays, as well as plasma display panels (PDPs), organic light emitting displays (OLEDs), field emission displays (FEDs), and foil displays.

It is to be further understood that even though numerous characteristics and advantages of various embodiments have been set forth in the foregoing description, together with details of the structures and functions of the embodiments, the disclosure is illustrative only, and changes may be made in detail to the full extent indicated by the broad general meaning of the terms in which the appended claims are expressed.

What is claimed is:

1. A display device comprising:
a plurality of pixels, each pixel comprising a red sub-pixel, a green sub-pixel, a blue sub-pixel, a cyan sub-pixel, a magenta sub-pixel, and a yellow sub-pixel, which are capable of displaying red, green, blue, cyan, magenta, and yellow, respectively, each of the cyan, magenta, and yellow sub-pixels being arranged generally between two corresponding of the red, green, and blue sub-pixels.

2. The display device as claimed in claim 1, wherein the red sub-pixel is adjacent to the cyan sub-pixel, the green sub-pixel is adjacent to the magenta sub-pixel, and the blue sub-pixel is adjacent to the yellow sub-pixel.

3. The display device as claimed in claim 1, wherein each pixel has a hexagonal structure that is divided into six regions, each sub-pixel occupying one corresponding region.

4. The display device as claimed in claim 3, wherein each pixel has a regular hexagonal structure, and each sub-pixel has an equilateral triangle structure.

5. The display device as claimed in claim 1, wherein each pixel has a parallelogram structure, the parallelogram structure is divided into six triangular regions, the red, blue, and green sub-pixels are located in three of the triangular regions that all have a first orientation, and the cyan, magenta, and yellow sub-pixels are located in the other three triangular regions that all have a second orientation, the second orientation being opposite to the first orientation.

6. The display device as claimed in claim 1, wherein each pixel has a rectangular structure, the six sub-pixels being arranged in a matrix with 2 rows and 3 columns.

7. The display device as claimed in claim 6, wherein the red, cyan, and blue sub-pixels are arranged from left to right in that order in a first row of the matrix, and the magenta, green, and yellow sub-pixels are arranged from left to right in that order in the second row of the matrix.

8. The display device as claimed in claim 1, wherein each pixel has a rectangular structure, the six sub-pixels being arranged in a line.

9. The display device as claimed in claim 8, wherein the red, green, and blue sub-pixels are separated from each other by two corresponding of the cyan, magenta, and yellow sub-pixels.

10. The display device as claimed in claim 9, wherein the red sub-pixel is adjacent to the cyan sub-pixel, the green sub-pixel is adjacent to the magenta sub-pixel, and the blue sub-pixel is adjacent to the yellow sub-pixel.

11. The display device as claimed in claim 1, wherein the display device is selected from the group consisting of a liquid crystal display, a cathode ray tube display, a flat intelligent tube display, a light emitting diode display, a plasma display panel, an organic light emitting display, a field emission display, and a foil displays.

12. A display device comprising:
a multiplicity of pixels, each pixel comprising:
a first display element, a second display element, and a third display element, which are able to display first, second, and third primary colors, respectively; and
a fourth display element, a fifth display element, and a sixth display element, which are able to display fourth, fifth, and sixth primary colors, respectively, the fourth, fifth, and sixth primary colors being complementary colors of the first, second, and third primary colors;
wherein in each pixel, the first, second, and third display elements are separated from each other by the fourth, fifth, and sixth display elements.

13. The display device as claimed in claim 13, wherein the first, second, third, fourth, fifth, and sixth display elements display red, green, blue, cyan, magenta, and yellow, respectively.

14. The display device as claimed in claim 14, wherein the first display element is adjacent to the fourth display element, the second display element is adjacent to the fifth display element, and the third display element is adjacent to the sixth display element.

15. The display device as claimed in claim 13, wherein each display element has an equilateral triangular shape, and each pixel has a regular hexagonal shape.

16. The display device as claimed in claim 13, wherein each pixel has a rectangular shape.
